(19) United States
(12) Patent Application Publication
(10) Pub. No.: US 2008/0196981 A1
(43) Pub. Date: Aug. 21, 2008

(54) DAMPENING DEVICE FOR COMPENSATING CABLES

(76) Inventors: David Liland, New Bern, NC (US); Didier Kaczmarek, Rocky Mount, NC (US)

Correspondence Address: WARD AND SMITH, P.A., 1001 COLLEGE COURT, P.O. BOX 867, NEW BERN, NC, 28563-0867, US

(21) Appl. No.: 12/033,764

(22) Filed: Feb. 19, 2008

Related U.S. Application Data
(60) Provisional application No. 60/890,292, filed on Feb. 16, 2007.

(51) Int. Cl. B66B 7/06

(52) U.S. Cl. 187/414; 242/615.4

(57) ABSTRACT

A sway reduction or dampening device operably engaging a wall adjacent an elevator car or floor of an elevator shaft, and receiving an elevator compensating cable is described. The device is made of two molded parts having an outer surface and inner surface with the inner surface for each part being complementary to each other to define a passage for a cable. The parts are made of molded material and include in one part molded rods which pass through corresponding openings in the other part. The two parts are held together through conventional securing elements such as nuts when the rods are threaded bolts. The nuts can be secured on the backside of a bracket to which the device is attached within an elevator shaft with an elevator cable passing therethrough.

### CROSS-REFERENCE TO RELATED APPLICATIONS

This Application is related to and claims priority to U.S. Provisional Application Ser. No. 60/890,292 filed Feb. 16, 2007, to which priority is claimed. The disclosure of said referenced Provisional Application is specifically incorporated by reference herein.

### FIELD OF THE INVENTION

The present invention relates to sway reduction or dampening devices for use with a cable, and more particularly for use with an elevator compensating cable. This invention also relates to an elevator system including such sway reduction devices.

### BACKGROUND OF THE INVENTION

Elevator hoistways typically include at least one elevator cable that supports and moves an elevator car and counterweight during operation of the car. The elevator compensating cable can be installed through a sway reduction device designed to dampen oscillations or cable swaying motion as the car and counterweight are moved.

Examples of known dampening devices include the Whisper-Flex® Dampening Device (WFDD) and the SwayLess Device (SLD) made commercially available by Draka Elevator Products, Inc. (DEP). In case of the WFDD, it includes a series of wear resistant and flame retardant rollers that are disposed on four sides of the elevator cable. The rollers are mounted to a metal frame by sealed bearings and brackets. A typical WFDD assembly can fill over 200 cubic inches of space. As part of the installation, four mounting holes each receive a respective mounting bolt for mounting the assembly to a stationary surface, for example, an elevator rail or support beam in an elevator hoistway.

The WFDD successfully performs the sway dampening function but has several disadvantages. For example, the device is expensive and installation can be difficult. More particular, assembly of the WFDD can be a time consuming procedure. The size and weight of the WFDD can make installation difficult in a crowded elevator hoistway.

Similarly, the SwayLess Device which is described in an exemplary manner in U.S. Pat. No. 6,234,277 is not without complications. First, it is not durable for long-term applications. In addition, only part of the device is of molded materials, and it is formed as a complex articulated element. Further it is of relatively thick size from top to bottom, and difficult to assemble around the elevator cables.

In accordance with the invention, a much simpler solution which is also more durable is provided by the invention than previously available.

### SUMMARY OF THE INVENTION

In accordance with the invention, a sway reduction device is designed for operably engaging a wall or floor adjacent of an elevator shaft either directly or through connecting members and brackets.

The sway reduction device is constructed for receiving an elevator compensating cable therethrough. A first molded part is provided having an outer surface and an inner curved surface for defining a first part of an aperture through which an elevator compensating cable is received. The first molded part includes solid first and second ends extending between the outer surface and the inner curved surface. Two parallel rods are molded respectively into the first and second ends and extend substantially parallel to the part of the aperture through which an elevator compensating cable is received. A second molded part has an outer surface and inner surface which is also curved for defining a second part of the aperture. Solid first and second ends extend between the outer surface and the inner curved surface and have openings on faces thereof extending through respective parts of the second molded part at locations for receiving the first and second rods respectively therein, and in a manner in which the rods project out of the second molded part when assembled with the first molded part. First and second securing members are provided for being engaged by the rods for holding the first and second molded parts together when assembled and for attaching the assembled parts to the wall or floor of an elevator shaft through appropriate brackets.

Preferably, the molded parts are made of cured urethane polymer, and more preferably one having lubricating properties. In a preferred aspect, the polymer is TDI urethane with a silicon additive blended in to provide lubricant properties. The first and second rods are typically threaded bolts molded into the first part and the securing members may be nuts with or without washers.

In another embodiment, the invention relates to an elevator system including an elevator car, a counterweight and an elevator compensating cable operably engaged within the elevator car and the counterweight. The cable is disposed and spaced in substantially parallel relation to a wall adjacent to the elevator car. A sway reduction device operably engages the wall and receives the elevator compensating cable passing through it, with the sway reduction device being constructed substantially as previously described.

These and other advantages and features that characterize the invention are set forth in the claims annexed hereto and forming a further part hereof. However, for a better understanding of the invention, and of the advantages and objectives attained through its use, reference should be made to the Drawings and to the accompanying descriptive matter in which there are described exemplary embodiments of the invention.

### BRIEF DESCRIPTION OF THE DRAWINGS

FIG. 1 is a perspective view of a sway reduction device in accordance with the invention mounted on a bracket attached to a wall of an elevator shaft and having an elevator cable passing therethrough.

FIG. 2 is a perspective view of a sway reduction device in accordance with the invention mounted on the rod attached to a floor of an elevator shaft.

FIG. 3 is a schematic view of an elevator system including sway reduction devices according to the present invention.

FIG. 4 is a top plan view of a sway reduction device in accordance with the invention shown in disassembled form.

FIG. 5 is a top plan view of a sway reduction device in accordance with the invention shown partially assembled.

FIG. 6 is a top plan view in partial cross section of a sway reduction device in accordance with the invention shown in partially assembled form.

### DETAILED DESCRIPTION

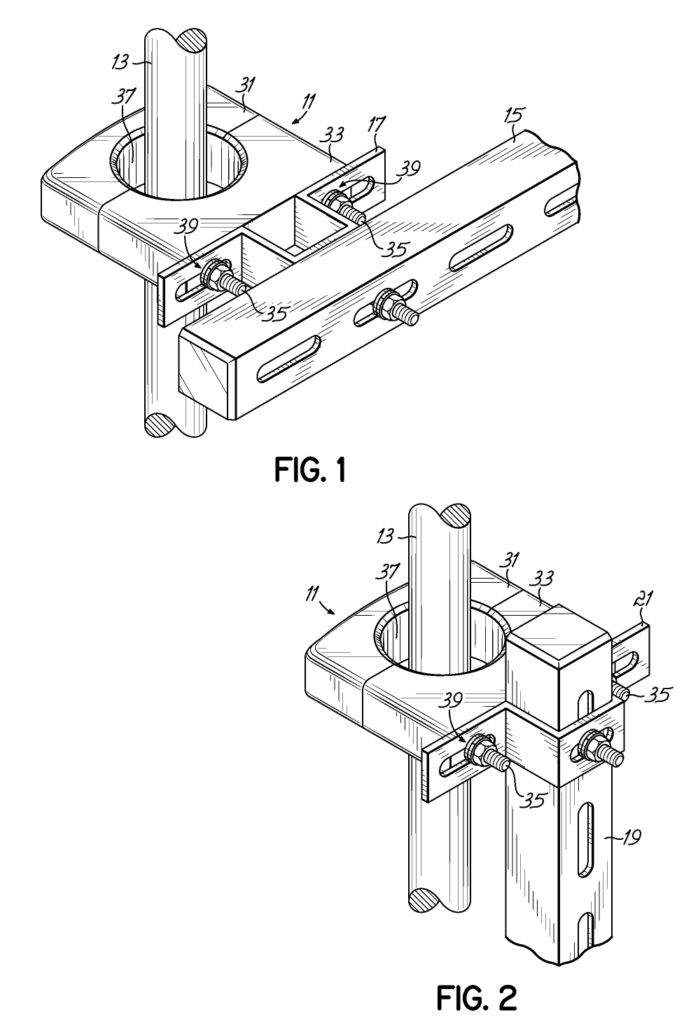

With reference to FIGS. 1, 2 and 4-6, embodiments of a sway reduction device 11 in accordance with the invention will be described. Sway reduction device 11 includes a cable 13 passage section 37 for passage of a cable 13. The sway reduction device 11 is adapted for mounting to walls of an elevator shaft through rails 15 having brackets 17 mounted on walls of an elevator shaft. In addition, near the bottom of an elevator shaft there may be provided floor rods 19 which include mounting brackets 21 also arranged for mounting a sway reduction device 11 in accordance with the invention. FIGS. 1 and 2 are exemplary views of such arrangements.

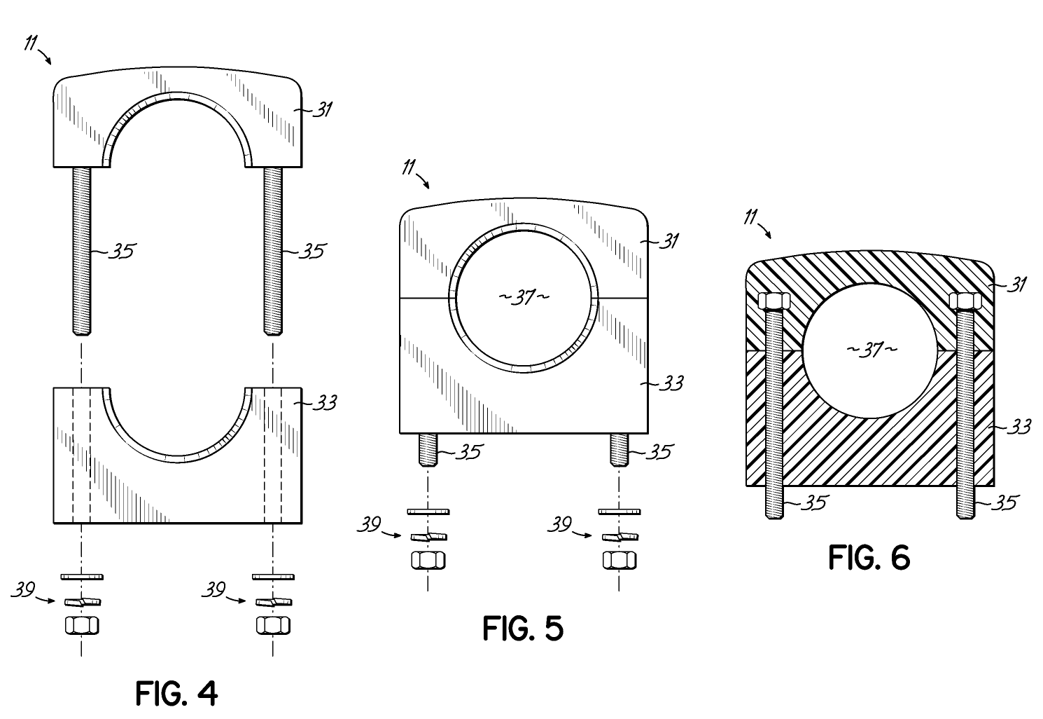

The sway reduction device 11 in accordance with the invention is shown in disassembled form in FIG. 4. A first molded part 31 includes an outer surface and an inner surface. The inner surface defines in part the cable passageway 37. Molded integrally with the first molded part 31 are rods 35, typically threaded bolts. A second molded part 33 includes a corresponding inner surface defining the passage 37 when assembled with part 31. Holes are molded through the second part 33 to allow passage of the rods 35 through the molded part 33 to be engaged with an assembly of nuts, lock washer and flat washer or other like combination 39, as shown in FIGS. 4 and 5. As further illustrated in FIG. 6, the rods 35 extend through the entire device 11 when assembled to be mounted. As further illustrated in FIGS. 1 and 2 the nuts and other securing components 39 are mounted on the backside of the brackets 17 and 21 to hold the sway reduction device 11 together and firmly secured to the brackets 17 and 21.

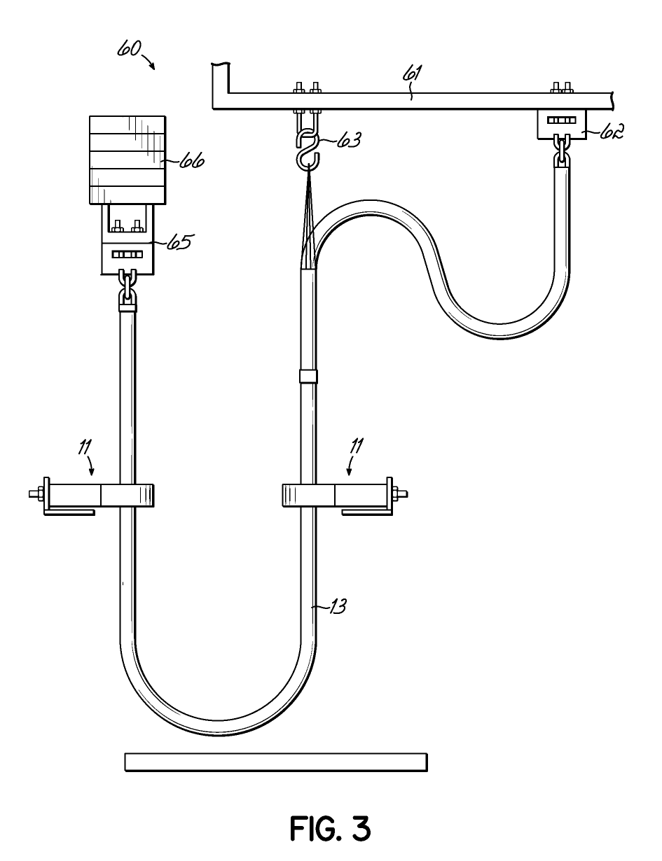

The sway reduction device 11 can be installed in an exemplary elevator system 60 shown schematically in FIG. 3. Elevator system 60 includes an elevator car 61 and an elevator compensating cable 13 attached to a support bracket 62 and a safety support 63. Compensating cable 13 passes through two sway reduction devices 11 and is attached to a counterweight support bracket 65 and a counterweight 66. In an exemplary installation procedure, sway reduction device 11 can be installed about an existing cable 13 by separating the two sections 31 and 33 to permit cable to be received between the two open parts 31 and 33. The two parts 31 and 33 are then assembled together and the bolts 35 are fastened to brackets, for example, 17 and 21 in FIGS. 1 and 2, with the nuts assembled on the back side of the brackets 17 and 21 so that sections 31 and 33 are held firmly together and on the bracket.

At this point, the sway reduction device 11 is firmly mounted and is ready to be impacted by the mass of cable 13. A typical elevator compensating cable 13 has a substantial mass and can include a heavy metal chain embedded in thermoplastic, metal filler beads and a durable outer jacket of thermoplastic. When cable 13 is moved during normal operation of system 60, this massive cable may sway and repeatedly impact the inner surfaced defining the passageway 37 of sway reduction device 11.

The sway reduction device 11 acts as a cushion in that it at least partially absorbs and dissipates energy transmitted from impact with the heavy mass of cable 13. The sway reduction device 11 is formed of a flexible, shock absorbent and moldable material that can function as a flexible spring and shock absorber. As shown in FIG. 3, due to the construction, the device 11 can be made of smaller profile than that of U.S. Pat. No. 6,234,277 (FIG. 7 of U.S. Pat. No. 6,234,277)

More particularly, the device 11 is preferably manufactured of a polymer, more particularly, a urethane polymer such as those that are readily commercially available, which when the parts 33 and 31 of the device 11 are manufactured through a conventional molding process, results in parts 31 and 33 which have a relatively high durometer hardness ratings, typically about 70-75 D. In a more specific aspect, the urethane is a TDI urethane which when cured has lubricating properties. In a more preferred embodiment, silicon is introduced into the polymer mix typically on the order of less than about 2% of the total mix by weight to provide further lubricating properties.

More specifically, the devices 11 are manufactured by mixing a curative prepolymer mixture and then placing it in an open cast mold with the rods 35 embedded to be molded therein. The passageways for part 33 are also molded through an appropriately dimensioned mold. Curing occurs in about 20 to 30 minutes and the parts 31 and 33 can then be demolded and cured in a heated oven at about 212 degrees Fahrenheit for between about 16-24 hours. More particularly, as may be appreciated by those of ordinary skill, the two half's are molded separately with the bolts molded as part of the first part 31 and the holes cast in place for the second part 33.

In an exemplary installation, the sway reduction device 11 is installed at a height about 3 to 3½ feet above the bottom of an elevator cable loop or the cable 13 to hit its top surface and fall outside the influence of the sway reduction device 11 and avoiding an entanglement of the cable 13 which would cause damage to the cable 13, the device 11 and respective mounting brackets. Thus, in accordance with the invention, the device 11 keeps the cable loop from coming into contact with the elevator shaft wall, the sides of the elevator and other elevator equipment in the elevator shaft. In addition, the device 11 minimizes cable jacket wear.

In accordance with the invention, numerous advantages are provided, for example, over devices such as that disclosed in U.S. Pat. No. 6,234,277. More particularly, only two sets of fasteners, i.e., bolts 35 are provided molded into one part 31 which holds two half's 31 and 33 together, and are used to mount the device to mounting brackets, such as brackets 17 and 21. The prior art includes much more complex constructions. In addition, by providing a simple two part device, a reduced height profile is provided. Further, the selected material of the device 11 will wear slowly and will last the life of the cable 13, typically on the order of 18 years. As a result of the simple construction, the curvature of the cable receiving aperture 37 can be made steeper with a greater radius to dampen cable oscillations more effectively than the previously employed devices, which include parts with different friction coefficients.

While the present invention has been illustrated in considerable detail, it is not the intention of the Applicants' to restrict, or any way limit the scope of the appended claims to such detail. The invention in its broader aspects is therefore not limited to the specific details, representative apparatus and method, and illustrative example shown and described. Accordingly, departures may be made from such details without departing from the spirit or scope of Applicants' general inventive concept.

1. A sway reduction device for operably engaging to a wall adjacent an elevator car or floor of an elevator shaft, and for receiving an elevator compensating cable therethrough, comprising:
a first molded part having an outer surface and an inner curved surface for defining a first part of an aperture through which an elevator compensating cable is received, and solid first and second ends extending between said outer surface and inner curved surface;
first and second rods molded respectively into said first and second ends and extending substantially parallel to said part of said aperture;
a second molded part having an outer surface and an inner curved surface for defining a second part of said aperture through which said elevator compensating cable is received, and solid first and second ends extending between said outer surface and said inner curved surface, said first and second ends having openings on faces thereof and extending through respective parts of said second molded part in a location for receiving said first and second rods respectively therein, to project out of said second molded part when assembled with said first molded part; and
first and second securing members for being engaged by said first and second rods for holding said first and second molded parts together when assembled and for attaching said assembled parts to said wall or floor.

2. The sway reduction device of claim 1, wherein said first and second molded parts are made of cured urethane polymer.

3. The sway reduction device of claim 1, wherein said first and second molded parts are made of a polymer having lubricating properties.

4. The sway reduction device of claim 1, wherein said first and second rods are threaded bolts, and said first and second securing members are nuts.

5. The sway reduction device of claim 3, further comprising said polymer having a lubricant additive blended therein.

6. An elevator system, comprising:
an elevator car;
a counterweight;
an elevator compensating cable operably engaged between the elevator car and the counterweight, the elevator compensating cable being adapted to be at least partially disposed in spaced and substantially parallel relation to a wall disposed adjacent to the elevator car, and said elevator car being located within an elevator shaft having said wall; and
a sway reduction device for receiving the elevator compensating cable therethrough, the sway reduction device comprising:
a cable-receiving structure comprising: a first molded part having an outer surface and an inner curved surface defining a first part of an aperture through which said elevator compensating cable is received, and first and second solid ends extending between said outer surface and inner curved surface; first and second rods molded respectively into said first and second ends and extending substantially parallel to said part of said aperture; a second molded part having an outer surface and an inner curved surface defining a second part of said aperture, and solid first and second ends extending between said outer surface and said inner curved surface, and said first and second ends having openings on faces thereof and extending through respective parts of said second molded parts and receiving said first and second rods respectively therein in a manner wherein said first and second molded parts are held together with said rods extending such as to be attached within said elevator shaft; and first and second securing members engaging said first and second rods to hold the first and second molded parts together secured within the shaft.

7. The elevator system as in claim 6, wherein said first and second molded parts are made of cured urethane polymer.

8. The elevator system as in claim 6, wherein said first and second molded are made of a polymer having lubricating properties.

9. The elevator system as in claim 6, wherein said first and second rods are threaded bolts and said first and second securing members are nuts.

10. The elevator system as in claim 8, further comprising said polymer having a lubricant additive blended therein.

11. The sway reduction device of claim 4, further comprising respective lock washers and flat washers receivable on said first and second rods respectively for securing said sway reduction device onto a bracket supported by a wall of an elevator shaft.

12. The sway reduction device of claim 4, further comprising respective lock washers and flat washers receivable on said first and second rods respectively for securing said sway reduction device onto a bracket supported by a rod mounted on the floor of an elevator shaft.

13. The sway reduction device of claim 1, wherein said first molded part and second molded part are made of a TDI urethane polymer with silicon having been introduced thereinto during manufacture in an amount of less than about 2% by weight and in a sufficient amount to provide lubricating properties to said first molded part and second molded part.

14. The sway reduction device of claim 5, wherein said lubricant additive is silicon in an amount of less than about 2% by weight and in a sufficient amount to provide lubricating properties to said first and said second molded parts.

15. The elevator system as in claim 9, further comprising respective lock washers and flat washers receivable on corresponding ones said first and second rods respectively for securing said sway reduction device onto a bracket supported by a wall of an elevator shaft.

16. The elevator system as in claim 9, further comprising respective lock washers and flat washers receivable on corresponding ones of said first and second rods respectively for securing said sway reduction device onto a bracket supported by a rod mounted on the floor of an elevator shaft.

17. The elevator system as in claim 6, wherein said first molded part and second molded part are made of a TDI urethane polymer with silicon having been introduced thereinto during manufacture in an amount of less than about 2% by weight, and in a sufficient amount to provide lubricating properties to said first molded part and second molded part.

18. The elevator system as in claim 10, wherein said lubricant additive is silicon in an amount of less than about 2% by weight, and in a sufficient amount to provide lubricating properties to said first and second molded parts.

19. The elevator system as in claim 6, further comprising a plurality of said receiving structures mounted in said elevator shaft having said elevator compensating cable passed therethrough.

20. The elevator system as in claim 6, wherein said cable-receiving structure is mounted in an elevator shaft within which said elevator car is received, at a height of about 3 feet to about 3.5 feet above the bottom of a loop of said elevator compensating cable.
